(19) United States
(12) Patent Application Publication
(10) Pub. No.: US 2025/0238526 A1
(43) Pub. Date: Jul. 24, 2025

(54) AUTOMATIC GENERATION OF PATCHES FOR EMBEDDED SOFTWARE

(71) Applicant: Robert Bosch GmbH, Stuttgart (DE)

(72) Inventors: Christopher Huth, Heilbronn (DE); Martin Ring, Lossburg (DE)

(21) Appl. No.: 19/022,368

(22) Filed: Jan. 15, 2025

(30) Foreign Application Priority Data
Jan. 19, 2024 (EP) 24 15 2762.1

(51) Int. Cl. G06F 21/57; G06F 8/65

(52) U.S. Cl. CPC G06F 21/577; G06F 8/65; G06F 2221/033

(57) ABSTRACT

A computer-implemented method for automatically generating a patch of software or of a part of the software designed to control, regulate and/or monitor a technical system or a part thereof. The method includes generating, via a machine learning model, at least one patch for a vulnerability of the software or the part thereof based on a prompt and a binary code of the software or the part thereof. A computer-implemented method for further training a machine learning model is also described, the machine learning model being designed to generate at least one patch for a vulnerability of software or a part of the software based on a prompt and a binary code of the software or the part thereof. The method includes adapting the machine learning model based on at least one generated patch and at least one evaluation result resulting from evaluating the at least one patch.

### BACKGROUND INFORMATION

Embedded software for controlling, regulating and/or monitoring technical systems, in particular cyber-physical systems, such as computing units of a vehicle, of a robot and/or of an industrial plant, is usually highly complex. As a result, it is challenging for individual software engineers and even entire software development departments to maintain an overview of software and its changes, in particular throughout its entire life cycle (development, testing, production and maintenance).

Software can be prone to errors and must therefore be tested thoroughly throughout its life cycle. The testing of (embedded) software is often integrated into a formalized validation and verification (V&V) process and is subject to a release process. For example, software can be tested for errors using static and/or dynamic software tests, wherein static software tests, unlike dynamic software tests, do not execute the software.

Particularly problematic are errors or vulnerabilities that impair or even jeopardize not only the functionality but also the security of the software and thus of the technical system it controls, regulates and/or monitors. This proneness is particularly great if the technical system has an interface to a public network (e.g., the Internet), because an attacker could then attempt to exploit the vulnerability of the software via this interface.

If a vulnerability of the software becomes known during the life cycle of the software, a patch can and should be generated for the software in order to prevent this vulnerability. This often requires swift action, especially if the software has one or more external parts for which a vulnerability becomes generally known, e.g., via a common vulnerabilities and exposures (CVE) database. Despite being supported by some tools, the creation of patches is still predominantly manual work and therefore time-consuming and expensive. With regard to the complexity of the software and the time sensitivity, a higher degree of automation would therefore be desirable.

The present invention addresses the problem of providing patches for software automatically, but nevertheless reliably.

### SUMMARY

A first general aspect of the present invention relates to a computer-implemented method for automatically generating a patch of software or (for automatically generating a patch) of a part of the software. According to an example embodiment of the present invention, the method comprises generating, via a machine learning model, at least one patch for a vulnerability of the software or the part thereof on the basis of a prompt and a binary code of the software or the part thereof. The (pre-trained) machine learning model can comprise a foundation model and/or a large language model (LLM).

The software can be embedded software. The (embedded) software can be designed to control, regulate and/or monitor a technical system or a part thereof. The technical system can in particular be a cyber-physical system. In particular, the software, and then the software modified by the at least one generated patch, can be designed to be executed in a cyber-physical system, in particular in at least one computing unit of a vehicle, of a robot or of an industrial plant. The software may, for example, be designed for a safety-critical task, in particular for a perception task, autonomous movement, powering, braking, and/or airbag control.

According to an example embodiment of the present invention, the method may comprise modifying the software on the basis of the at least one generated patch. The method may comprise executing the software modified by the at least one generated patch, in the technical system, in particular in the cyber-physical system.

A second general aspect of the present invention relates to a computer-implemented method for further training a machine learning model, wherein the machine learning model is (pre-trained and) designed to generate at least one patch for a vulnerability of software or of a part of the software on the basis of a prompt and a binary code of the software or the part thereof. According to an example embodiment of the present invention, the method comprises adapting the machine learning model on the basis of at least one patch generated according to the method according to the first general aspect (or an embodiment thereof) and at least one evaluation result resulting from evaluating the at least one patch.

A third general aspect of the present invention relates to a computer system that is designed to perform the computer-implemented method for automatically generating a patch of software or of a part of the software according to the first general aspect (or an embodiment thereof) and/or to perform the computer-implemented method for further training a machine learning model according to the second general aspect (or an embodiment thereof).

A fourth general aspect of the present invention relates to a computer program that is designed to perform the computer-implemented method for automatically generating a patch of software or of a part of the software according to the first general aspect (or an embodiment thereof) and/or to perform the computer-implemented method for further training a machine learning model according to the second general aspect (or an embodiment thereof).

A fifth general aspect of the present invention relates to a computer-readable medium or signal that stores and/or contains the computer program according to the fourth general aspect (or an embodiment thereof).

The method according to the first aspect (or an embodiment thereof) of the present invention is aimed at automatically generating patches (at least one patch) of the software. The high degree of automation makes it possible to adapt the software at any time and in particular whenever a vulnerability becomes known, i.e., promptly after the vulnerability becomes known. This will prevent vulnerabilities as quickly as possible. This is achieved by the machine learning model with a sufficiently large understanding of machine language and, in embodiments, by automatically evaluating the at least one patch of the software according to established V&V methods. This makes it possible to utilize the machine creativity of the machine learning model, while at the same time ensuring the quality of the patches, and thus of the software modified by the patches (“patched software”). In other words, errors, in particular faulty patches, which may occasionally be produced by the machine learning model, are detected by the V&V methods reliably or at least with a sufficiently high probability before such patched software is used. As a result, the functionality and security of the software and, for example, of the technical system, such as a vehicle, a robot and/or an industrial plant, controlled, regulated and/or monitored by the software can be improved.

In addition, it is possible to test at any time during the lifecycle of the software whether the software is affected by a vulnerability.

An advantage of the method according to the first general aspect of the present invention (or an embodiment thereof) is that patches are generated starting from binary code and/or, in embodiments, from code decompiled from the binary code. The patches are thus not generated on one or more source codes, which may be written in different programming languages. As a result, the method is equally applicable to software in any compilable programming languages and does not have to be laboriously adapted to a specific programming language or newly developed, as was previously the case. Another advantage is that the method can also be used if the source code is not available, as is often the case with external software components.

Thanks to the high degree of automation, a multitude of patches can be generated for a vulnerability of the software. In particular, the variability (e.g., through random selection) in the output of the machine learning model (which can be referred to as the temperature in technical jargon) allows many different patches to be generated and subsequently evaluated. The best patch can then be selected and the software can be modified by this patch.

The method according to the present invention can also be used in order to supplement an existing set of patches with further patches, which, for example, are to fulfill a different purpose and/or cover other aspects. In addition, existing patches that have not been evaluated sufficiently well can be adapted, improved and/or corrected in further iterations of the method.

A further advantage is that the resulting patches and their evaluations can be used to further train a domain-specific patch generator. This can be effected, for example, as in the method 200 according to the second general aspect (or an embodiment thereof). As a result, supervised fine-tuning and/or unsupervised (reinforcement) learning can be carried out on the basis of the evaluation results, and thus the method according to the first general aspect (or an embodiment thereof) can be improved. This will then (in the future) make it possible to generate patches for the software even more reliably. Here, too, the multitude of patches generated for a vulnerability proves to be advantageous because they increase the amount of training data on the basis of which the machine learning model can be trained further.

### BRIEF DESCRIPTION OF THE DRAWINGS

FIG. 1A schematically illustrates exemplary embodiments of a computer-implemented method for automatically generating a patch of software or of a part of the software, according to the present invention.

FIG. 1B schematically illustrates an exemplary embodiment of a computer-implemented method for automatically generating a patch of software or of a part of the software, according to the present invention.

FIG. 2 schematically illustrates exemplary embodiments of a computer-implemented method for further training a machine learning model designed to generate at least one patch for a vulnerability of software or of a part of the software on the basis of a prompt and a binary code of the software or the part thereof, according to the present invention.

### DETAILED DESCRIPTION OF EXAMPLE EMBODIMENTS

The method 100 according to an example embodiment of the present invention proposed in this disclosure is aimed at automatically generating patches of software for avoiding vulnerabilities. In particular, the software can be embedded software designed to be executed on an embedded (i.e., for example, task-specific) system. This system can be a computing unit. This computing unit is often a control device or an electronic control unit (ECU).

Software errors, and in particular exploitable errors (vulnerabilities), are a major problem for cybersecurity. This applies not only to server software, but basically to all software. However, as soon as this software is exposed to the Internet, the possibilities of attack increase significantly since attacks on such software can spread to all connected instances. On the other hand, from a certain level of complexity, it would be arbitrarily expensive to develop completely error-free software. No matter how much effort is made to avoid errors and in particular vulnerabilities in the software before it is released, it can never be ruled out that software is delivered with errors and/or vulnerabilities and is used in a technical system, for example. It is therefore important, especially for safety-critical applications, that software can be patched even after delivery and depending on its criticality.

Patching is also expensive; developers must, for example, reproduce the error and/or vulnerability, estimate the criticality and then write an appropriate patch that meets all release criteria. This assumes that the error has already been discovered.

Vulnerabilities of external parts of software can become generally known, for example, through a vulnerability database (common vulnerabilities and exposures (CVE) database). The following example from the National Vulnerability Database of the National Institute of Standards and Technology (NIST), nvd.nist.gov/vuln/detail/CVE-2017-14937, shows that a vulnerability can be given by a natural language description:
“CVE-2017-14937 Detail
. . .

### DESCRIPTION

The airbag detonation algorithm allows injury to passenger-car occupants via predictable Security Access (SA) data to the internal CAN bus (or the OBD connector). This affects the airbag control units (aka pyrotechnical control units or PCUs) of unspecified passenger vehicles manufactured in 2014 or later, when the ignition is on and the speed is less than 6 km/h. Specifically, there are only 256 possible key pairs, and authentication attempts have no rate limit. In addition, at least one manufacturer's interpretation of the ISO 26021 standard is that it must be possible to calculate the key directly (i.e., the other 255 key pairs must not be used). Exploitation would typically involve an attacker who has already gained access to the CAN bus, and sends a crafted Unified Diagnostic Service (UDS) message to detonate the pyrotechnical charges, resulting in the same passenger-injury risks as in any airbag deployment.”

In particular, for processing such natural language descriptions, a large language model (LLM) can, for example, be used as a machine learning model 30. The goal is to automatically patch the vulnerable software. For this purpose, software and in particular its binary code (i.e., its one or more binary files) can be continuously tested and analyzed for vulnerabilities. If such a vulnerability is found, a patch can be created automatically.

Machine learning models, in particular large language models, are becoming increasingly powerful and already have the potential to achieve low error rates similar to those of the human mind. Nevertheless, machine learning models, just like a software engineer, can generate incorrect answers. The generated patches are therefore, preferably, evaluated automatically.

For this purpose, verification and validation methods (V&V) can be used to evaluate the generated patch. This can, for example, detect more, fewer or different problems with the patched software. In addition, the patch can (and should) be tested for functionality identical to (or improved in comparison to) that of the original binary file. If all tests are sufficiently satisfactory, software modified by the patch (patched software), in particular one or more patched binary files, can be released for use.

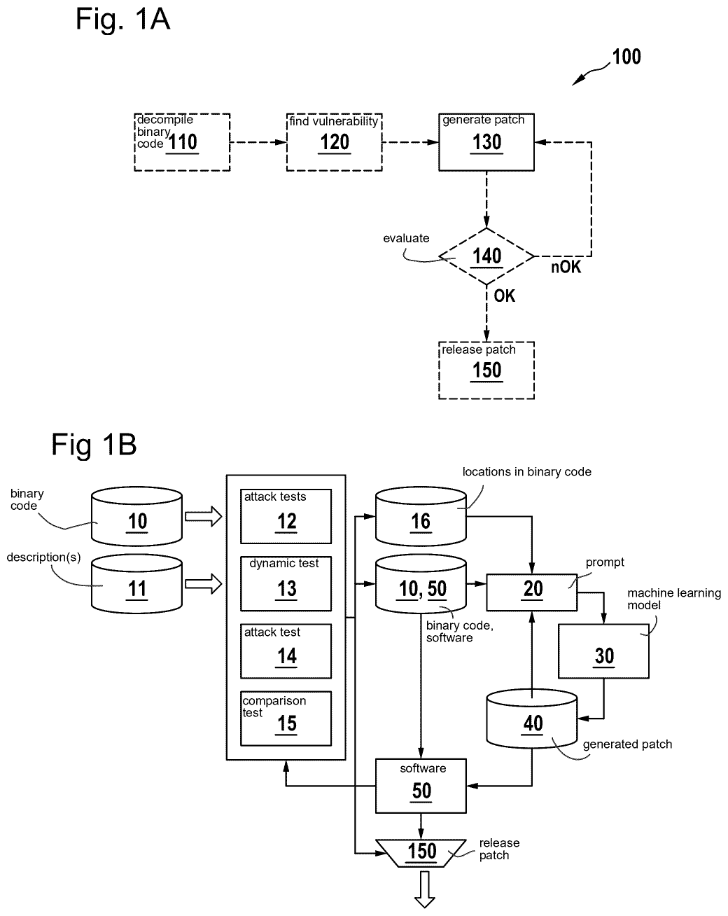

Disclosed first is a computer-implemented method 100, as illustrated schematically in FIG. 1A-1B, for example, for automatically generating a patch of software or of a part of the software (i.e., for generating a patch of software or a patch of a part of the software).

The method 100 comprises generating 130, via a machine learning model 30, at least one patch 40 for a vulnerability of the software or the part thereof on the basis of a prompt 20 and a binary code 10 of the software or the part thereof.

The software can comprise binary code, in particular one or more binary files (e.g., executable files and/or libraries). In the case of a plurality of binary files, a part of the software may be a binary file, for example. The part of the software may also be part of a binary file.

The at least one generated patch 40 may also be code, in particular binary code as well, which replaces the software, the part of the software or a subpart of the part of the software, wherein the part of the software modified by the patch and/or the software modified by the patch is the result.

The machine learning model 30 can comprise a foundation model and/or a large language model (LLM). In particular, the machine learning model 30 can be a foundation model and/or a large language model (LLM).

The method 100 may comprise generating a multitude of patches for the vulnerability.

The software can be designed to control, regulate and/or monitor a technical system or a part thereof. The software can be embedded software. The embedded software can be designed to control, regulate and/or monitor a technical system or a part thereof. The technical system can in particular be a cyber-physical system. In particular, the software, and then the software modified by the at least one generated patch, can be designed to be executed in a cyber-physical system, in particular in at least one computing unit of a vehicle, of a robot or of an industrial plant. In particular, the technical system can be the vehicle, the robot or the industrial plant. The software may, for example, be designed for a safety-critical task, in particular for a perception task, autonomous movement (e.g., autonomous driving of a vehicle or autonomous moving of a robot), powering, braking, and/or airbag control.

As illustrated schematically in FIG. 1A, for example, the method 100 may comprise decompiling 110 the binary code 10, wherein a decompiled code, in particular an intermediate representation of the binary code, a machine code and/or an assembly code is the result (i.e., is generated), wherein the generation 130 of the at least one patch 40 is based on the decompiled code. The decompiled code may or may not be source code. The intermediate representation of the binary code may or may not be machine code and/or assembly code. The intermediate representation may be a representation between the binary code and the source code. The intermediate representation of the binary code may, for example, comprise a control flow graph of the software.

The prompt may comprise a natural language instruction to the machine learning model. The natural language instruction may comprise a request to generate at least one or a multitude of patches for a vulnerability in the binary code 10. The prompt 20 may comprise the binary code 10. Alternatively or additionally, the prompt 20 may comprise the decompiled code. In particular, the prompt 20 may comprise the binary code 10 and the decompiled code.

Alternatively or additionally, in the method 100, the at least one patch 40 for a vulnerability of the software or the part thereof may be generated 130 on the basis of the prompt 20 and an intermediate representation of the binary code (e.g., a machine code or assembly code of the software). The method 100 may then comprise translating one or more source codes of the software into the intermediate representation of the binary code (e.g., into the machine code and/or into the assembly code).

As illustrated schematically in FIG. 1A, for example, the method 100 may comprise finding 120 the vulnerability on the basis of the binary code 10. Alternatively or additionally, the method 100 may comprise finding 120 the vulnerability on the basis of the decompiled code. In particular, the method 100 may comprise finding 120 the vulnerability on the basis of the binary code and the decompiled code.

Finding 120 the vulnerability may be based on one or more attack tests 12.

Alternatively or additionally, finding 120 the vulnerability may be based on one or more descriptions (as exemplified above) of at least one known vulnerability. In particular, finding 120 the vulnerability may be based on at least one attack test 12 and at least one description of a vulnerability. The description of the at least one known vulnerability may be (natural language) text.

An attack test may comprise an executable script or program designed to test whether the vulnerability of the software can be exploited when the software is executed.

The method 100 may comprise generating the attack test, in particular via a further machine learning model, on the basis of the binary code 10 and a further prompt. Alternatively or additionally, generating the attack test may be based on the decompiled code or the otherwise generated intermediate representation of the binary code (e.g., machine code or assembly code of the software). Alternatively or additionally, generating the attack test may be based on the description of the at least one known vulnerability. The further machine learning model may comprise (or be) a further foundation model and/or a further large language model. The further machine learning model may or may not be the machine learning model.

Finding 120 the vulnerability, in particular generating the attack test, on the basis of the description of the at least one known vulnerability may be based on the further machine learning model. Alternatively or additionally, finding 120 the vulnerability may be based on parsing and/or on input via a user interface. Alternatively or additionally, finding 120 the vulnerability (e.g., when evaluating 140) may be based on a static test of the software or part thereof, in particular based on the decompiled code or the otherwise generated intermediate representation of the binary code (e.g., machine code or assembly code of the software). Alternatively or additionally, finding 120 the vulnerability (e.g., when evaluating 140) may be based on a dynamic test of the software or part thereof.

By finding 120 the vulnerability, one or more locations 16 in the binary code and/or in the decompiled code can be ascertained. The one or more locations can be encoded, for example, by a stack trace of a crash in a dynamic test. For example, a stack trace may comprise a record of the last functions up to the time of the crash.

As illustrated by way of example in FIG. 1B, the prompt 20 may comprise the one or more locations 16 of the vulnerability.

As schematically illustrated in FIG. 1A, for example, the method 100 may comprise evaluating 140 the at least one patch 40, wherein an evaluation result is the result. The method 100 may thus comprise evaluating the software modified by the patch (i.e., the patched software). The evaluation result may, for example, comprise a binary variable (e.g., 0 or, as in FIG. 1A, “nOK” for a negative evaluation result or 1 or “OK” for a positive evaluation result). Alternatively or additionally, the evaluation result may comprise a variable with a multitude of values, in particular for a degree of positivity of the evaluation result.

In the event that a multitude of patches is generated 130 for the vulnerability, a plurality, in particular all, of these patches can be evaluated 140 in the method 100. In this case, each evaluation result may be the result for each evaluated patch or such evaluation results may be contained and/or combined in one evaluation result.

Evaluating 140 the at least one patch may comprise a static test 12 of the software 50 modified by the patch or of the part thereof modified by the patch. Alternatively or additionally, evaluating 140 the at least one patch may comprise a dynamic test 13 of the software modified by the patch or of the part thereof modified by the patch. Alternatively or additionally, evaluating 140 the at least one patch may comprise an attack test 14 of the software modified by the patch or of the part thereof modified by the patch. Alternatively or additionally, evaluating 140 the at least one patch may comprise a comparison test 15 designed to compare the software or part thereof with the software modified by the patch or with part thereof modified by the patch. In particular, it can be checked whether the software and the patched software are identical in terms of functionality. Alternatively or additionally, it can be checked here whether the patched software is better than the software (e.g., shorter runtime, less memory requirement, lower energy consumption, etc.). Alternatively or additionally, evaluating 140 the at least one patch may comprise a non-functional test of the software modified by the patch or of the part thereof modified by the patch. The non-functional test can in particular test the performance, runtime and/or memory requirement of the software modified by the patch. As schematically illustrated in FIG. 1B, for example, evaluating 140 the at least one patch may comprise a static test 12, a dynamic test 13, an attack test 14 and a comparison test 15.

The evaluation result can be determined according to a predetermined criterion (or a plurality of criteria) from results of one or more of these tests.

The (at least one) static test can be based on abstract interpretation and taint checking. The software or part thereof does not have to be executed for this purpose.

The (at least one) dynamic test can be designed to execute the software or part thereof on predetermined (at the time of the test) input data and to test whether a crash occurs. Such a crash can be documented, for example, by a stack trace in the evaluation result. The dynamic test can be based on fuzzing. In fuzzing, the software or part thereof can be dynamically tested (in so-called fuzzing iterations) using a multitude of predetermined input data. Dynamic tests can be used at different integration levels of the software.

In the case of an attack test, for example, a positive evaluation result can be issued if the vulnerability could no longer be exploited.

In the case of a multitude of tests for evaluating the at least one patch, the method 100 may comprise successively calculating the evaluation result for the at least one generated patch. The method 100 may comprise aborting the evaluation 140 of the at least one patch if the evaluation result is already (sufficiently) negative. This can save time, energy and costs.

The method may comprise modifying the software or the part thereof on the basis of the at least one generated patch. Modifying the software or part thereof may comprise replacing one or more binary files of the binary code with one or more patched binary files.

The method may comprise executing the software modified by the at least one generated patch, in the technical system, in particular in the cyber-physical system.

As schematically illustrated in FIG. 1A-1B, for example, the at least one patch can be released 150 if the evaluation result is positive (OK). Alternatively or additionally, the release of the software modified by the at least one patch (patched software) may be made conditional on (e.g., as a necessary condition) the at least one patch having been released. The release of the software modified by a multitude of patches may be made conditional on each patch of the multitude of patches having been released.

In case a multitude of patches are generated 130 and evaluated 140 for the vulnerability, a patch (i.e., the at least one patch) can be selected from the multitude of patches on the basis of each evaluation result. This can be done automatically within the method 100 and/or manually via a user interface (e.g., in an electronic programming environment).

As schematically illustrated in FIG. 1A, for example, the method 100 may be repeated 151 if the evaluation result is negative (nOK). In doing so, at least one further patch may be generated on the basis of the at least one patch 40.

The prompt for reperforming the method 100 may comprise the at least one patch 40. The prompt for reperforming the method 100 may comprise a request to improve and/or correct the at least one patch 40, in particular with regard to the evaluation result. For example, if already patched software only has minor runtime problems at certain locations, these locations can be fed back into the machine learning model and specifically improved.

The generation of the at least one patch in the reperformance of the method 100 may be based on the software modified by the at least one patch 40 or on the part of the software modified by the at least one patch 40. For this purpose, the binary code may, for example, be exchanged before the method is reperformed. Alternatively or additionally, the prompt for reperforming the method 100 may comprise (in addition to the previous binary code) the software modified by the at least one patch 40 or the part of the software modified by the at least one patch 40. In this case, too, the prompt for reperforming the method 100 may comprise a request to improve and/or correct the at least one patch 40, in particular with regard to the evaluation result.

An exemplary embodiment of the method 100 is explained in more detail with reference to FIG. 1B.

It shows a plurality of inputs, such as collections, for a V&V framework:
Binary code 10 of the software: Binary code may, for example, be binary files that are to be patched, or those that are to be examined for vulnerabilities, such as classes of the same software. It may also be part of a binary file, for example when inline assembly is used, or only a fragment of an executable file.
One or more descriptions 11 of at least one known vulnerability: This database may be filled, for example, by standard CVE databases and other known vulnerabilities (e.g., with vulnerabilities known only internally).

A further input not shown in FIG. 1B could comprise 14, for example, known attacks and their patterns: While the previous database helps to identify the location of an error, it cannot target and exploit a vulnerability. Some form of execution, such as a script or program, should be used for this purpose. This database contains scripts that attempt to trigger common exploits automatically.

For example, the V&V framework contains all (or a part of) the dynamic 13 and static 12 tests, and it checks whether an error and in particular a vulnerability exists. The output of this V&V framework may, for example, be the location of the binary code where an error may still be located, or that a binary program fails certain tests, or that everything has been passed.
Static tests 12: The static tests include static analyses, such as abstract interpretation and taint analysis, which can detect errors (or at least warn that an error and in particular a vulnerability may be present). Static tests do not execute the software, but scan the binary files themselves.
Dynamic tests 13: Dynamic tests may comprise, for example, fuzzing, in which the fuzzing tool generates numerous inputs into the software being tested, in order to see if this input causes the software to crash. Other dynamic tests comprise unit tests (e.g., more specific component tests), component tests and integration tests, which ensure the correctness of the software at least for the given test cases.
Automatic attacks 14 (attack test): Automatic attacks may be scripts from the database of known attacks and their patterns, such as an automatic exploit. This can be used to determine whether software is still vulnerable to a particular exploit.
Comparison tests 15: This is about comparing the software with the software modified by the patch. The software modified by the patch should, for example, have the same or improved functionality.

Not shown are further non-functional tests that test the performance, runtime and/or memory requirement of the software modified by the patch. They may also be contained in the V&V framework.

The following intermediate results can be provided (successively) from one or more tests:
Locations 16 with vulnerable code: If the test result indicates the location of an error or at least a warning about an error, then these locations can be entered as input into the prompt 20. This may include, for example, stack traces of crashes found through fuzzing. These locations help locate the error when the binary files or parts of the binary files are passed to the prompt.
Binary files to be fixed: Here, the complete binary file 10, 50 or only a part thereof can be given to the prompt 20. A simple control flow analysis, e.g., with ghidra, can reveal branches and basic code blocks in order to cut out these locations. In case of doubt, the complete binary file can also be passed to the prompt. Together with the vulnerable code locations 16 from the other prompt inputs, the machine learning model 30, in particular a large language model, can identify where the specific problem lies.
Prompt 20: This may be the prompt for the large language model, which, for example, as shown schematically in FIG. 1B, can be generated from up to three inputs, namely from the binary files 10, 50 to be fixed, the vulnerable locations 16 and optionally (in a reperformance of the method 100) the at least one generated 130 patch.

Further elements are:
Machine learning model 30: The machine learning model, in particular the large language model, is stimulated with the prompt 20, and the output is a binary code as the patch 40, which is then applied to the binary program 10, 50. The V&V framework can now be used to check the patched software 50 for correctness and, in particular, as to whether the identified error has been eliminated.
Patches 40: This is the output of the machine learning model. At the same time, it may also be the third input for the prompt 20 since it is possible in this way to present the machine learning model again with patches that have not worked so far.
Patched binary files 50: After a patch 40 has been created, it can be applied to a binary file (or a plurality of binary files if the error occurs in a plurality of binary files). Patched binary files 50 and, if necessary, the entire patched software can be provided as input to the V&V framework.
Release 150: Only if the patched binary file successfully passes the V&V framework, i.e., is functionally correct and the binary file has not deteriorated, e.g., with respect to the execution speed, the patched binary file is released and can be distributed.

Also disclosed is a computer-implemented method 200 for further training a machine learning model 30, wherein the machine learning model 30 is designed to generate 130 at least one patch 40 for a vulnerability of software or of a part of the software on the basis of a prompt 20 and a binary code 10 of the software or the part thereof. The machine learning model 30 may be the machine learning model from the method 100. In particular, the machine learning model 30 may already be trained in advance.

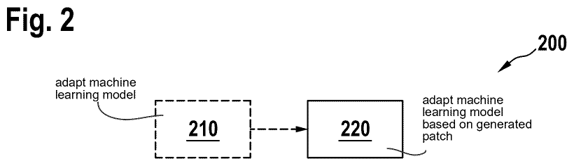

The method 200, schematically illustrated in FIG. 2, comprises adapting 220 the machine learning model 30 on the basis of at least one patch generated 130 according to the method 100 and an evaluation result for the at least one generated 130 patch. The evaluation result can result from the method 100 by evaluating 140 the at least one patch 40. Alternatively or additionally, one or more patches generated independently of the method 100 and the associated evaluation results may also be used when adapting 220 the machine learning model 30.

As in FIG. 2, for example, the method 200 may comprise calculating 210 at least one reward on the basis of the at least one evaluation result. Adapting 210 the machine learning model 30 on the basis of the at least one evaluation result may then be based on the at least one reward. In this respect, the better the at least one evaluation result is, the greater the reward can be, and the worse the at least one evaluation result is, the lower the reward can be.

Adapting 210 the machine learning model 30 may be based on proximal policy optimization (PPO). When adapting 210, one or more parameters (e.g., weights and/or biases) of the machine learning model 30 may be adapted.

Alternatively or additionally, adapting the machine learning model 30 may also be based on supervised learning. The evaluation result for each generated patch can also be used for this purpose.

Aborting early when evaluating 140, if the evaluation result is already sufficiently negative, can also be advantageous for the method 200 because it shortens the computing time.

Also disclosed is a computer system designed to perform the computer-implemented method 100 for automatically generating a patch of software or of a part of the software. Alternatively or additionally, the computer system can be designed to perform the computer-implemented method 200 for further training a machine learning model. In particular, the computer system can be designed to perform the computer-implemented method 100 for automatically generating a patch of software or of a part of the software and (e.g., subsequently) to perform the computer-implemented method 200 for further training a machine learning model. The computer system can comprise a processor and/or a working memory.

Also disclosed is a computer program designed to perform the computer-implemented method 100 for automatically generating a patch of software or of a part of the software. Alternatively or additionally, the computer program can be designed to perform the computer-implemented method 200 for further training a machine learning model. In particular, the computer program can be designed to perform the computer-implemented method 100 for automatically generating a patch of software or of a part of the software and (e.g. subsequently) to perform the computer-implemented method 200 for further training a machine learning model. The computer program can be present, for example, in interpretable or in compiled form. For execution, it can (even in parts) be loaded into the RAM of a computer, for example as a bit or byte sequence.

Also disclosed is a computer-readable medium or signal that stores and/or contains the computer program. The medium can comprise, for example, any one of RAM, ROM, EPROM, HDD, SSD, . . . , on/in which the signal is stored.

1-15. (canceled)

16. A computer-implemented method for automatically generating a patch of software or of a part of the software, wherein the software is configured to control and/or regulate and/or monitor a technical system or a part of the technical system, the method comprising:
generating, via a machine learning model, at least one patch for a vulnerability of the software or the part of the software based on a prompt and a binary code of the software or the part of the software.

17. The method according to claim 16, wherein the machine learning model includes a foundation model and/or a large language model (LLM).

18. The method according to claim 16, wherein the software is configured to be executed in a cyber-physical system, including at least one computing unit of: a vehicle, or a robot, or an industrial plant.

19. The method according to claim 16, wherein the software is configured for a safety-critical task including: a perception task and/or autonomous movement and/or powering and/or braking and/or airbag control.

20. The method according to claim 16, further comprising:
decompiling the binary code, wherein a decompiled code, including: (i) an intermediate representation of the binary code and/or (ii) a machine code and/or (iii) an assembly code, is a result of the decompiling, wherein the generating of the at least one patch is based on the decompiled code.

21. The method according to claim 16, further comprising:
finding the vulnerability based on the binary code.

22. The method according to claim 21, wherein the finding of the vulnerability is further based on an attack test and/or a description of at least one known vulnerability.

23. The method according to claim 16, further comprising:
evaluating the at least one patch, wherein an evaluation result is a result.

24. The method according to claim 23, wherein the evaluating of the at least one patch includes:
(i) a static test of the software modified by the patch or of the part of the software modified by the patch, and/or
(ii) a dynamic test of the software modified by the patch or of the part of the software modified by the patch, and/or
(iii) an attack test of the software modified by the patch or of the part of the software modified by the patch, and/or
(iv) a comparison test which is configured to compare the software or the part of the software with the software modified by the patch or with the part of the software modified by the patch, wherein it is checked whether the software or the part of the software with the software modified by the patch or with the part of the software modified by the patch are identical in terms of functionality, and/or
(v) a non-functional test of the software modified by the patch or of the part of the software modified by the patch, wherein the non-functional test tests performance and/or runtime and/or memory requirement of the software modified by the patch; and
wherein the evaluation result is determined according to a predetermined criterion from results of one or more of these tests.

25. The method according to claim 23, wherein the at least one patch is released when the evaluation result is positive.

26. The method according to claim 23, wherein the method is repeated when the evaluation result is negative.

27. The method according to claim 26, wherein at least one further patch is generated based on the at least one patch.

28. A computer-implemented method for further training a machine learning model, wherein the machine learning model is configured to generate at least one patch for a vulnerability of software or a part of the software based on a prompt and a binary code of the software or the part of the software, the method comprising:
adapting the machine learning model based on at least one patch generated by:
generating, via the machine learning model, the at least one patch for a vulnerability of the software or the part of the software based on a prompt and a binary code of the software or the part of the software,
evaluating the at least one patch, wherein an evaluation result is a result,
adapting the machine learning model based on the result of the evaluating.

29. The method according to claim 28, further comprising:
calculating at least one reward based on the the evaluation result;
wherein the adapting the machine learning model based on the evaluation result is based on the at least one reward.

30. The method according to claim 29, wherein the at least one reward is greater when the at least one evaluation result is better, and wherein the at least one reward is lower when the at least one evaluation result is worse.

31. The method according to claim 29, wherein the adapting of the machine learning model is based on proximal policy optimization.

32. A computer system configured to:
(i) automatically generate a patch of software or of a part of the software, wherein the software is configured to control and/or regulate and/or monitor a technical system or a part of the technical system, the automatic generating including generating, via a machine learning model, at least one patch for a vulnerability of the software or the part of the software based on a prompt and a binary code of the software or the part of the software; and/or
(ii) train the machine learning model, including adapting the machine learning model based on at least one patch generated by:
generating, via the machine learning model, the at least one patch for a vulnerability of the software or the part of the software based on a prompt and a binary code of the software or the part of the software,
evaluating the at least one patch, wherein an evaluation result is a result,
adapting the machine learning model based on the result of the evaluating.

33. A non-transitory computer-readable medium on which is stored a computer program, the computer program, when executed by a computer system, causing the computer system to perform the following steps:
(i) automatically generate a patch of software or of a part of the software, wherein the software is configured to control and/or regulate and/or monitor a technical system or a part of the technical system, the automatic generating including generating, via a machine learning model, at least one patch for a vulnerability of the software or the part of the software based on a prompt and a binary code of the software or the part of the software; and/or
(ii) train the machine learning model, including adapting the machine learning model based on at least one patch generated by:
generating, via the machine learning model, the at least one patch for a vulnerability of the software or the part of the software based on a prompt and a binary code of the software or the part of the software,
evaluating the at least one patch, wherein an evaluation result is a result,
adapting the machine learning model based on the result of the evaluating.
